(19) United States
(12) Patent Application Publication
(10) Pub. No.: US 2006/0195697 A1
(43) Pub. Date: Aug. 31, 2006

(54) Method of supplying power to time-stamping device, security device, and time-correcting device

(75) Inventors: Ryota Akiyama, Kawasaki (JP); Takeaki Kawashima, Tokorozawa (JP)

Correspondence Address: GREER, BURNS & CRAIN, 300 S WACKER DR, 25TH FLOOR, CHICAGO, IL, 60606, US

(73) Assignee: FUJITSU LIMITED & CITIZEN WATCH CO., LTD.

(21) Appl. No.: 11/178,529

(22) Filed: Jul. 11, 2005

(30) Foreign Application Priority Data
Feb. 28, 2005 (JP) 2005-053593

(51) Int. Cl. H04L 9/00

(52) U.S. Cl. 713/178

(57) ABSTRACT

A power supply controller controls power supply to each unit included in a time-stamping device. The power supply controller determines which unit is to be supplied with power according to the length of the period when the time-stamping device is not used. However, the power supply controller continuously supplies power to an authentication key storing unit that stores an authentication key for receiving an authentic time from a time server to prevent falsification of the local time of the time-stamping device.

### BACKGROUND OF THE INVENTION

1. Field of the Invention

The present invention relates to a technology for power-supply control in a time-stamping device that affixes a digital signature including therein a local time of the time-stamping device.

2. Description of the Related Art

With the recent developments in the field of electronic authentication technology, digital signatures that authenticate a creator or publisher of electronic documents have come to be widely used. The digital signature uses technology such as encryption key, etc. to enhance its reliability. Further, attempts have been made to include the national standard time (hereinafter, “standard time”) in the digital signature to authenticate the creation time or transmission time of the electronic document.

A device that affixes a digital signature with a time stamp is generally known as a time-stamping device. The time-stamping device has an internal clock. As well as clocking the local time according to the internal clock, the time-stamping device also corrects the local time by receiving radio waves that include the standard time, thereby enhancing the accuracy of the time stamped in the digital signature.

To affix a digital signature with a time stamp, it is essential to keep the difference between the local time of the time-stamping device and the standard time within a predetermined threshold value. That is, by ensuring that the difference between the time included in the digital signal and the standard time is kept within the predetermined threshold value, the time stamp of the electronic document that is to be digitally signed can be authenticated.

One method that may be employed for keeping the difference between the local time and the standard time within the predetermined threshold level is by receiving the radio wave, as described earlier. Another method is by connecting to a standard time managing server connected to a network and obtaining the standard time from the server. For instance, the standard time managing server disclosed in Japanese Patent Laid-Open Publication No. 2002-229869 transmits the standard time with an expiration data to a client device that is constantly connected to the server, and detects any deviation or tampering with the internal clock of the client device.

However, in the conventional time-stamping device fraudulent falsification of the local time cannot be prevented. For instance, the local time of the time-stamping device can be manipulated to be much ahead of or behind the authentic time with the aid of a radio wave including therein a false standard time instead of the true standard time. Thus, the time stamp on the electronic document cannot be authenticated with this kind of doctored local time.

Thus, in a conventional time-stamping device, power needs to be supplied to an internal time calibration signal receiver and an internal clock of the time-stamping device during the period between the manufacturing of the time-stamping device and its purchase by a user (hereinafter, “inventory period”) to prevent falsification of the local time. Particularly, a battery that can last during the longest estimated inventory period needs to be provided on the time-stamping device when a long inventory period is estimated.

Further, with the public preference for compact devices, the need of the hour is a compact time-stamping device that does not require to be connected all the time to a network, such as a local area network (LAN), and that can be carried around like a wrist watch or a mobile, and used whenever required. Thus, it is important to make the battery compact.

In the technology disclosed in Japanese Patent Laid-Open Publication No. 2002-229869, the standard time managing server is always connected to the client device, which is connected to the network such as the LAN. Thus, although falsification of the local time can be prevented after the operation of the time-stamping device is started, falsification of the local time during the inventory period cannot be prevented.

Thus, it is important to realize a time-stamping device that can prevent falsification of the local time by an unauthorized user and reduce the power consumption during the inventory period and the operational period.

### SUMMARY OF THE INVENTION

A time-stamping device according to an aspect of the present invention, which affixes a digital signature including a local time clocked by an internal clock to electronic data, includes: an authentication-key storing unit that stores an authentication key; an authentic-time receiving unit that receives an authentic time synchronized with a standard time from a time server by sending a request including the authentication key stored; a time correcting unit that corrects the local time based on the authentic time received; and a power-supply control unit that supplies a power to a plurality of units included in the time-stamping device. The power-supply control unit keeps on supplying the power to the authentication key storing unit.

A security device according to still another aspect of the present invention, which sends and receives data by means of an authentication key, includes: an authentication-key storing unit that stores the authentication key; and a power-supply control unit that supplies a power to a plurality of units included in the security device. The power-supply control unit keeps on supplying the power to the authentication key storing unit.

A time-correcting device according to still another aspect of the present invention, which corrects a local time by receiving an authentic time from a time server by means of an authentication key, includes: an authentication-key storing unit that stores the authentication key; and a power-supply control unit that supplies a power to a plurality of units included in the time-correcting device. The power-supply control unit keeps on supplying the power to the authentication key storing unit.

A method according to another aspect of the present invention, which is a method for supplying a power to a time-stamping device that affixes a digital signature including a local time clocked by an internal clock to electronic data, includes: storing an authentication key in a storage unit of the time-stamping device; receiving an authentic time synchronized with a standard time from a time server by sending a request including the authentication key stored; correcting the local time based on the authentic time received; and supplying a power to a plurality of units included in the time-stamping device. The power is continually supplied to the storage unit.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a time-stamping device according to an embodiment of the present invention;

FIG. 2A is a drawing of a first example of the time-stamping device;

FIG. 2B is a drawing of a second example of the time-stamping device;

FIG. 2C is a drawing of a third example of the time-stamping device;

FIG. 3 is a drawing of operating modes of the time-stamping device;

FIG. 4 is a functional block diagram of the time-stamping device;

FIG. 5 is a drawing of an example of a relation between the operating modes and units receiving the power supply;

FIG. 6 is a drawing of an example of the power consumed in each of the operating modes;

FIG. 7 is a flowchart of a sequence of a power supply controlling process;

FIG. 8 is a flowchart of sequences of a time modification process and a time correction process;

FIG. 9 is a drawing of a computer that executes a time correction program and a power supply control program;

FIG. 10 is a schematic diagram of a conventional time-stamping device; and

FIG. 11 is a drawing of drawbacks related to the power supply of the conventional time-stamping device.

### DETAILED DESCRIPTION OF THE PREFERRED EMBODIMENTS

Exemplary embodiments of the present invention are explained in detail with reference to the accompanying drawings.

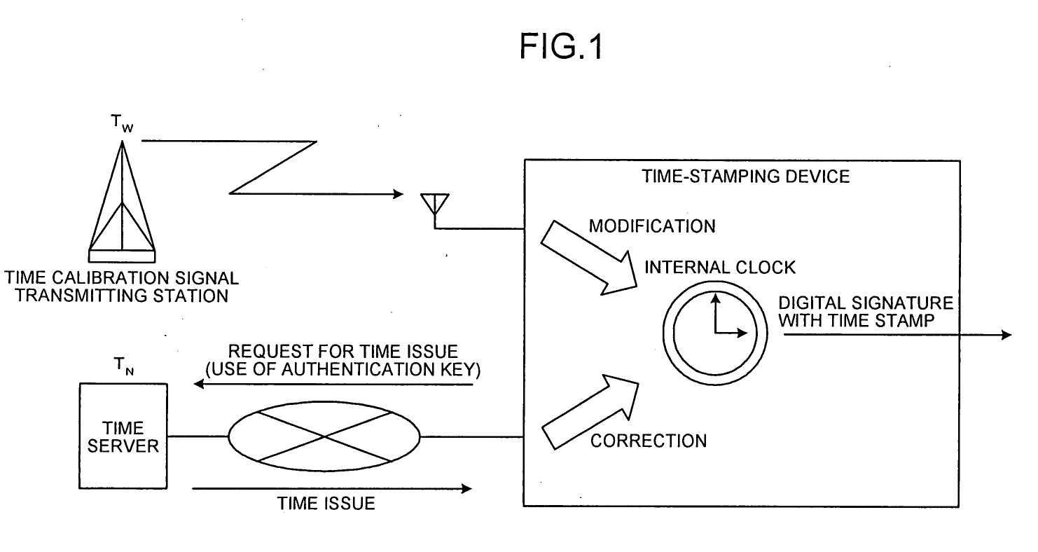

A time-stamping device that incorporates a power supply controlling process, which is a feature of the present embodiment, is explained first with reference to FIG. 1 through FIG. 2C and FIG. 10 through FIG. 11.

Time-stamping device refers to a device that affixes a digital signature including therein a time stamp on any digital data such as an electronic document. It has become commonplace in recent years to exchange digital data over the network, thus spawning the enterprise of authenticating the creation date, transmission date of the digital data (the so-called “time business”).

For example, apart from medical electronic document data such as a medical record or death certificate, or accounting or tax-related documents such as sales account document or receipts, electronic documents to substantiate the date of invention of patents, digital signature with a time-stamping device can be affixed on image data, video data, etc. to authenticate the correct time at which these digital data were created or transmitted. Further, the time-stamping device can be included in digital cameras and digital video cameras, thereby extending the application of time business to the fields where there is requirement of data and time stamping.

Management of the time included in the digital signature is very crucial in the time business. In other words, the mechanism not only should ensure accurate time, but also deter any fraudulent falsification of the time. The time is likely to be tampered with for fraudulent activities such as for concealing a medical blunder or for changing the date of invention in patents, etc. Thus, it is essential to deter such misdeeds by disabling alteration of time.

One aspect of the time business requires that the time is synchronized between a facility or a device that issues reliable time and the several time-stamping devices that receive the time issued from the facility or the device. Time servers serve as a reliable time source and provide standard time by connecting and presenting an authentication key to a time calibration signal transmitting station or a satellite that issues radio waves including therein the standard time.

The businesses that manufacture and sell time-stamping devices for expanding the time business must ensure that the difference between the “Time” stamped with the digital signature by the time-stamping device and the standard time does not exceed a predetermined value. This assurance will help establish time business.

However, the possible presence of defrauders who falsify the time in the digital signature by altering the time can be a real threat to the very time business as the time of creation or transmission cannot be authenticated.

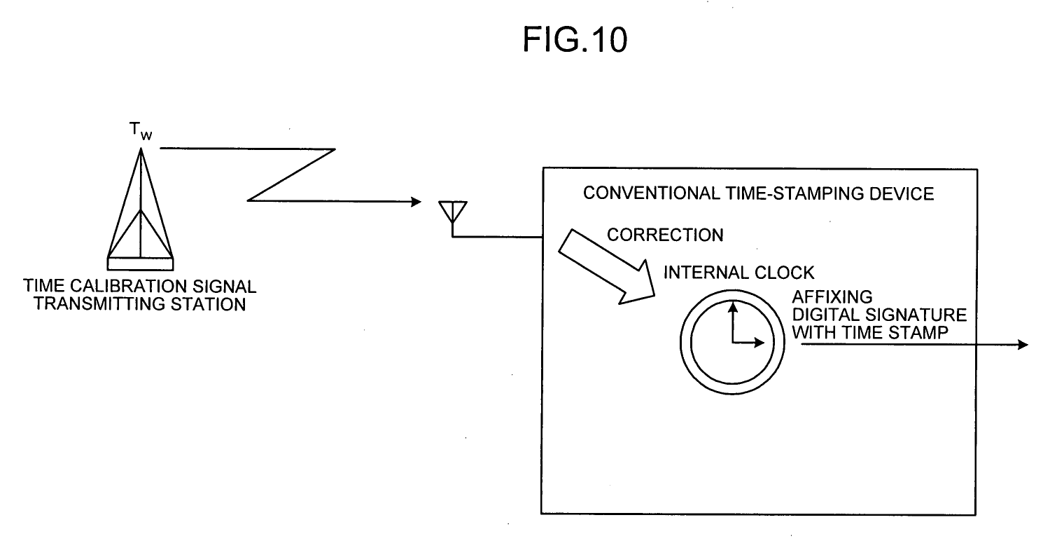

FIG. 10 is a schematic diagram of the conventional time-stamping device. An internal clock is provided inside the conventional time-stamping device. The time of the internal clock is modified by a radio time (T_{W}) included in the time calibration signal transmitted by the time calibration signal transmitting station. During digital signature the time stamp that is affixed is according to the modified internal clock. The conventional time-stamping device incorporates the so-called “radio clock” function.

In the conventional time-stamping device, if the difference between the local time of the internal clock and the radio wave time (T_{W}) included in the time calibration signal exceeds a predetermined threshold value, the signing process is halted, thereby preventing falsification of the local time by an unauthorized user. However, for such a preventive measure to function effectively the internal clock needs to be kept in continuous operation and the time calibration signals need to be continuously received once the time-stamping device is manufactured.

This is because halting the operation of the internal clock or the receiving of the time calibration signals results in the difference between the local time of the internal clock and the radio wave time (T_{W}) exceeding the predetermined threshold value and the signing process is halted.

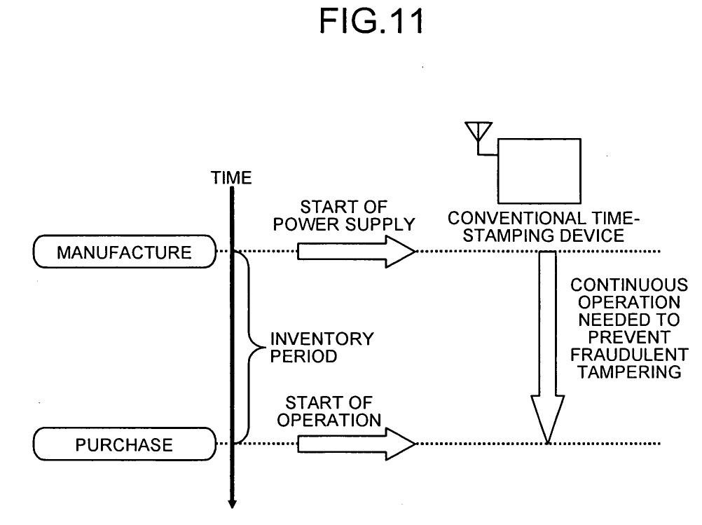

FIG. 11 is a drawing of the drawbacks related to the power supply of the conventional time-stamping device. A commodity circulation of the conventional time-stamping device is shown in FIG. 11.

As shown in FIG. 11, the period between the manufacturing of the time-stamping device and its purchase by a user is called “inventory period”. In the conventional time-stamping device, the internal clock needs to be kept in continuous operation and the time calibration signals need to be continuously received even during the inventory period to prevent falsification of the local time. Thus, a continuous power supply has to be provided to the internal clock and a time calibration signal receiver after the time-stamping device is manufactured.

Particularly, a battery that can last during the longest estimated inventory period needs to be provided on the time-stamping device when a long inventory period is estimated, thereby hampering the efforts to make the time-stamping device more compact. Moreover, to provide a compact time-stamping device which can be carried around like a wrist watch or a mobile and used whenever required, the battery to be provided also needs to be made compact. Thus, it is important to reduce the power consumption of the time-stamping device during the inventory period.

In the time-stamping device according to the present embodiment, a power supply mechanism is provided which reduces the power consumption not only during the inventory period, but also during the period when the time-stamping device is not used after the time-stamping device has become operational (hereinafter, “shelf period”).

FIG. 1 is a schematic diagram of the time-stamping device according to the present embodiment. Apart from the radio wave time, the time-stamping device according to the present embodiment also receives an authentic time (T_{N}) from a time server via a network and corrects the local time of the internal clock according to the authentic time.

The time server refers to a device that is connected to a network such as the Internet and that provides, upon presentation of the authentication key, a highly reliable standard time maintained by it over the network. In the present embodiment, the time-stamping device is described as receiving the authentic time (T_{N}) from the time server. However, the time-stamping device may also receive the authentic time (T_{N}) from a server that is not provided with the standard time issuing function but is connected to a time issuing device having that function. Alternatively, the time-stamping device may receive the authentic time (T_{N}) from the time issuing device directly connected to the network.

The time-stamping device according to the present embodiment provides an authentication key when requesting the time server for the issue of the standard time. Thus, the standard time having a high reliability can be received from the time server if the time-stamping device maintains the authentication key. In the conventional time-stamping device, the internal clock needs to be kept in continuous operation and the time calibration signals need to be continuously received to prevent falsification of the local time by an unauthorized user.

However, in the time-stamping device according to the present embodiment, the internal clock need not be kept in continuous operation and the time calibration signals need not be continuously received. This is because by providing the authentication key, the standard time can be received from the time server at a predetermined time. Further, a random access memory (RAM), which is a volatile memory, is used to store the authentication key, and power is continuously supplied to the volatile RAM to prevent an unauthorized user from receiving hold of the authentication key.

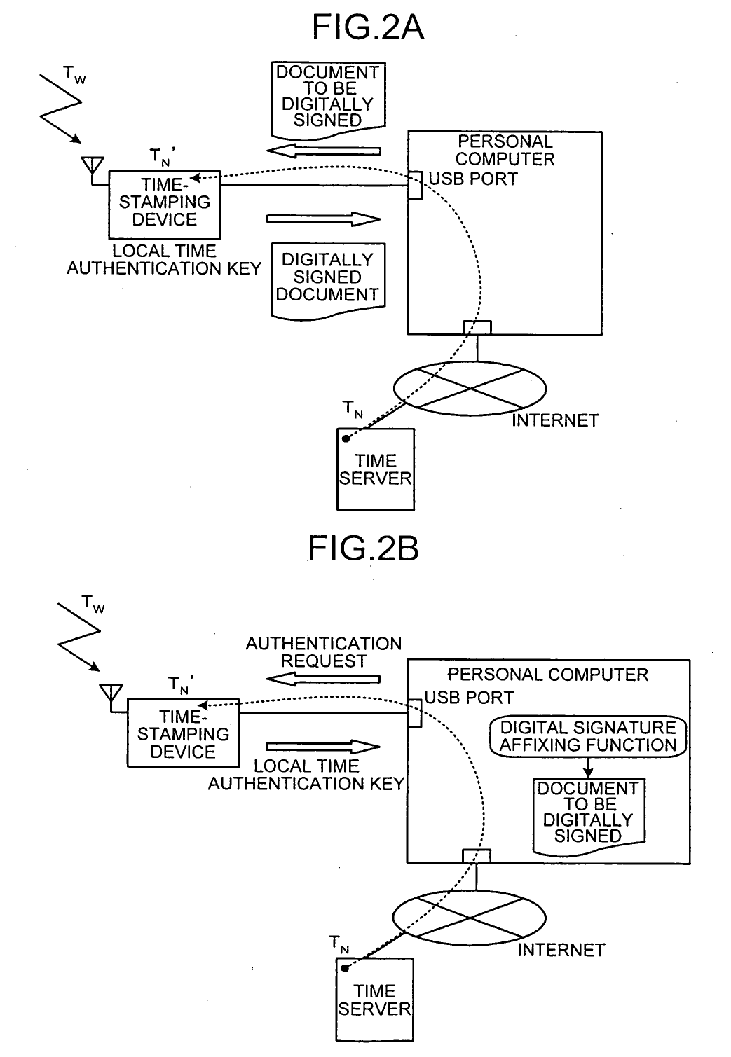

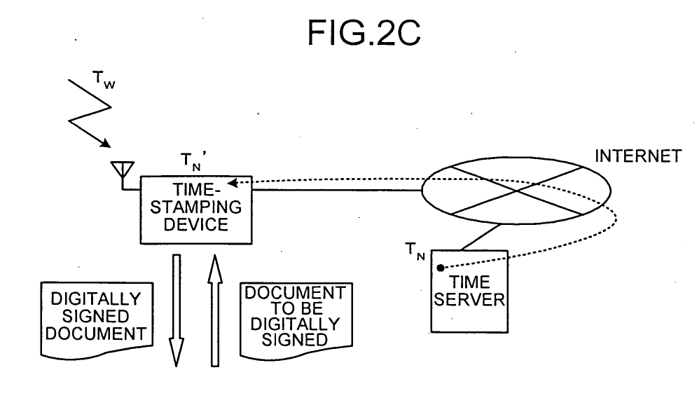

The different structures of the time-stamping device according to the present embodiment are explained next with reference to FIG. 2A through FIG. 2C. The structures shown in FIG. 2A through FIG. 2C are supposedly for portable time-stamping device that is constructed with a view to make it portable like a wrist watch or a mobile. However, it is also possible to adapt these structures for stationary time-stamping device.

FIG. 2A is a drawing of a first example of the time-stamping device. In this structure, the time-stamping device is connected to a universal serial bus (USB) port of a personal computer connected to the Internet. The time-stamping device thus connected receives the electronic document to be digitally signed from the personal computer, affixes a digital signature on the electronic document using its local time (T_{N}′) and the authentication key, and transfers the digitally signed document to the personal computer. When correcting time, the time-stamping device connects to the time server via the personal computer and the Internet, and receives the authentic time (T_{N}).

FIG. 2B is a drawing of a second example of the time-stamping device. The time-stamping device shown in FIG. 2B is similar to the one shown in FIG. 2A and is used by connecting to the USB port of the personal computer connected to the Internet. However, the function of affixing the digital signature is carried out by a program installed in the personal computer.

When a digital signature is required, the personal computer sends an authentication request message to the time-stamping device via the USB port. Upon receiving the message, the time-stamping device sends the local time and the authentication key to the personal computer. The personal computer then affixes the digital signature on the document using the function of affixing digital signature that the personal computer itself possesses. When correcting time, the time-stamping device shown in FIG. 2B, like the one shown in FIG. 2A, connects to the time server via the personal computer and the Internet.

FIG. 2C is a drawing of a third example of the time-stamping device. The time-stamping device shown in FIG. 2C is directly connected to the Internet. Upon receiving the electronic document to be digitally signed from an outside source, the time-stamping device affixes the digital signature using the local time (T_{N}′) and the authentication key, and outputs the digitally signed electronic document. The document to be digitally signed may be an electronic document stored in the internal memory of the time-stamping device. When correcting time, the time-stamping device shown in FIG. 2C connects to the time server via the internet and receives the authentic time (T_{N})

In the time-stamping devices shown in FIG. 2A through FIG. 2C, the digital data to be digitally signed is assumed to be text data. However, image data or video data can also be digitally signed in the same manner. Further, the time-stamping device may be incorporated in devices such as digital cameras and the images as they are taken may be digitally signed.

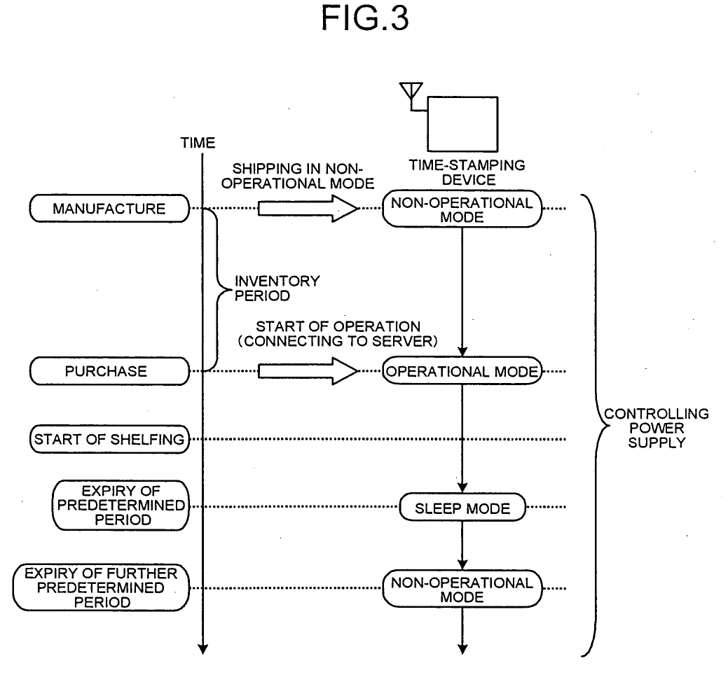

FIG. 3 is a drawing of operating modes of the time-stamping device according to the present embodiment. As shown in FIG. 3, a “non-operational mode”, an “operational mode”, and a “sleep mode” are the three operating modes provided in the present embodiment. However, instead of providing the aforementioned three operating modes, the “non-operational mode” and the “operational mode” can be provided as the two operating modes, and a plurality of operating modes can be provided in between the “non-operational mode” and the “operational mode”.

During the “non-operational mode” power is supplied only to the volatile RAM, which stores the authentication key. During the “operational mode” power is supplied to all the functioning units of the time-stamping device. During the “sleep mode” power supply to specified functioning units is halted.

As shown in FIG. 3, the time-stamping device is manufactured and shipped in the “non-operational mode”. When a user purchases and connects the time-stamping device to the time server to start the operation of the time-stamping device, the operating mode of the time-stamping device changes to the “operational mode”. Thereafter, the user always uses the time-stamping device in the “operational mode”. The operating mode changes to the “sleep mode” if the time-stamping device is not used for a predetermined period, and changes to the “non-operational mode” if the time-stamping device is not used for a further predetermined period.

In the time-stamping device according to the present embodiment, the standard time is received from the time server. The power supply is controlled to reduce the power consumption during the inventory period and the shelf period. Thus, falsification of the local time by an unauthorized user can be prevented and the power consumption of the time-stamping device during the inventory period and the operational period can be reduced.

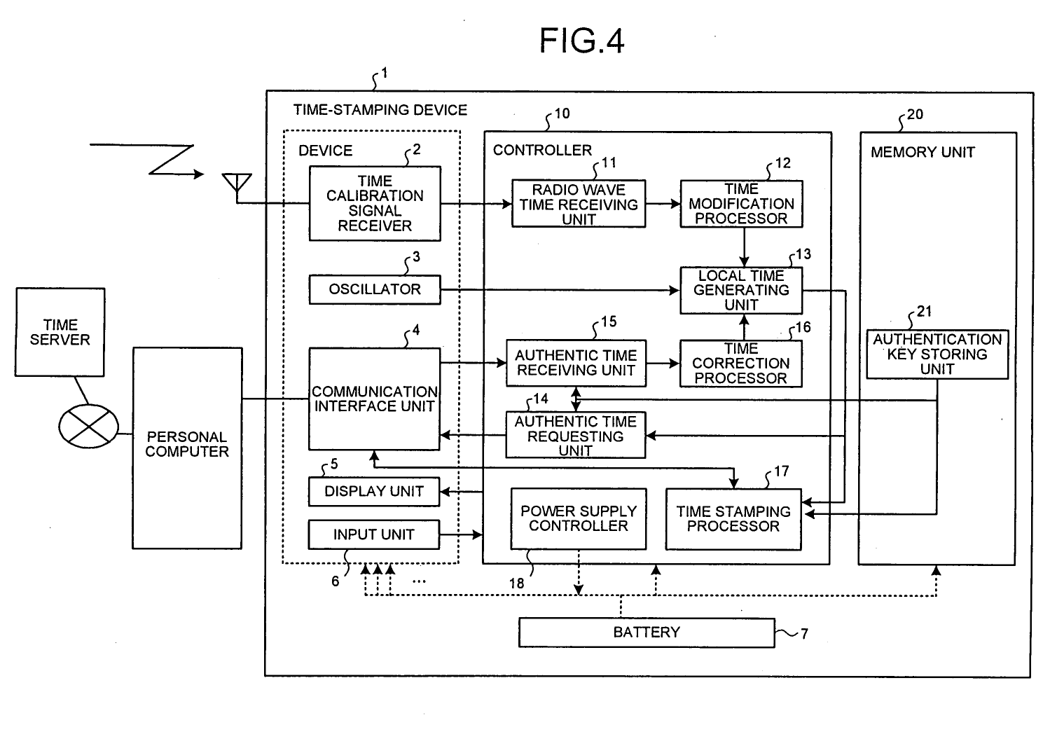

FIG. 4 is a functional block diagram of the time-stamping device that incorporates a power supply controlling process, which is a feature of the present embodiment. FIG. 4 depicts the structure of a time-stamping device 1 when the time-stamping device 1 takes the structure shown in FIG. 2A.

As shown in FIG. 4, the time-stamping device 1 includes a time calibration signal receiver 2, an oscillator 3, a communication interface unit 4, a display unit 5, and an input unit 6, and further includes a controller 10 and a memory unit 20.

The controller 10 includes a radio wave time receiving unit 11, a time modification processor 12, a local time generating unit 13, an authentic time requesting unit 14, an authentic time receiving unit 15, a time correction processor 16, a time stamping processor 17, and a power supply controller 18. The memory unit 20 further includes an authentication key storing unit 21.

The time calibration signal receiver 2 receives the time calibration signal from a time calibration signal transmitting station or a satellite, and passes on the radio wave time (T_{W}) synchronized with the national standard time to the controller 10. For instance, the time calibration signal transmitted from the time calibration signal transmitting station includes time information such as hour, minute, second, number of days from the start of the year, year (last two digits according to western calendar), day of the week, etc. The time calibration signal receiver 2 may be set to receive the time calibration signal at any time. For instance, the time at which the time calibration signal receiver 2 receives the time calibration signal may be specified as 7:00 hrs and 19:00 hrs. Apart from the set time, the user can also bring about a forced reception of the time calibration signal at any time.

The oscillator 3 clocks the local time of the crystal oscillator and feeds the oscillated pulse to the controller 10. As the time-stamping device 1 is expected to be operated under a wide range of temperatures, and as an anticipatory measure against temperature assault with a view to tamper with the time, it is preferable that TCXO is used as the oscillator 3, so that accuracy of time is guaranteed under a wide range of temperatures.

The TCXO is provided with the temperature compensating circuit. Because oscillation errors due to temperature change are compensated by means of the temperature compensating circuit, the amount of power consumed by the TCXO is several times that of a conventional crystal oscillator. Thus, halting the power supply to the TCXO according to the operational requirements can effectively control the amount of power consumption of the time-stamping device 1.

The communication interface unit 4 is a device such as the USB port, LAN board, etc., that allows two-way communication, and facilitates data exchange between the time-stamping device 1 and the personal computer, as well as between the communication interface unit 4 and the controller 10. Further, the communication interface unit 4 also allows data exchange between the time-stamping device 1 and the time server.

The display unit 5 is a display device such as a liquid crystal display and displays alerts, error information, etc. from the controller 10 and other devices. The input unit 6 is a power on/off button and is used for switching the time-stamping device 1 on or off. The operation of the input unit 6 is notified to the controller 10. For example, the result of the operation acts as a trigger to change the operating mode from the aforementioned “sleep mode” to the “operational mode”.

The controller 10 generates the local time and appropriately carries out time modification according to the time calibration signal and time correction according to the authentic time, keeping the difference between the local time and the authentic time within the predetermined value, and affixes the digital signature using the local time. The controller 10 also controls the power supply to each of the units.

The radio wave time receiving unit 11 receives the radio wave time (T_{W}) from the time calibration signal receiver 2 and passes it on to the time modification processor 12. The time modification processor 12 uses the radio wave time (T_{W}) received from the radio wave time receiving unit 11 to modify the local time (T_{N}′) generated by the local time generating unit 13.

Specifically, the time modification processor 12 calculates an absolute value (|T_{W}−T_{N}′|) of the difference between the radio wave time (T_{W}) and the local time (T_{N}′) and compares the absolute value (|T_{W}−T_{N}′|) with the predetermined threshold value (ε). If the absolute value (|T_{W}−T_{N}′|) is less than the threshold value (ε) (that is, if |T_{W}−T_{N}′|<ε), the time modification processor 12 replaces the local time (T_{N}′) with the radio wave time (T_{W}). When the absolute value |T_{W}−T_{N}′| is less than the threshold value E a predetermined number of successive times, it acts as a trigger for the authentic time requesting unit 14 to make a request to the time server for the authentic time.

If the absolute value (|T_{W}−T_{N}′|) is equal to or greater than the threshold value (ε) (that is, if (|T_{W}−T_{N}′|≧ε), the time modification processor 12 does not modify the local time (T_{N}′). When the absolute value (|T_{W}−T_{N}′|) is equal to or greater than the threshold value (ε) a predetermined number of successive times, it acts as a trigger for the authentic time requesting unit 14 to make a request to the time server for the authentic time.

The local time generating unit 13 receives the pulse output from the oscillator 3 and generates the local time (T_{N}′) based on the pulse. The local time (T_{N}′) is subjected to time modification process by the time modification processor 12 according to the radio wave time (T_{W}) as well as to the time correction process by the time correction processor 16 according to the authentic time (T_{N}). The local time generating unit 13 notifies the generated local time (T_{N}′) to the authentic time requesting unit 14 and the time stamping processor 17.

The authentic time requesting unit 14, at specified times, makes a request to the time server connected to the network for the issue of the authentic time using the local time (T_{N}′) generated by the local time generating unit 13 and the authentication key stored in the authentication key storing unit 21. When making the request for the issue of the authentic time, the authentic time requesting unit 14 encrypts the request message containing the local time (T_{N}′) using the authentication key and sends the encrypted request message to the communication interface unit 4.

The authentic time requesting unit 14 can be forcibly made to request for the authentic time by the user. In addition, the authentic time requesting unit 14 makes a request for the authentic time upon triggered by “number of successive times |T_{W}−T_{N}′|<ε” and “number of successive times |T_{W}−T_{N}′|≧ε” calculated by the time modification processor 12.

For instance, assuming that ε is 0.5 second, and that the time modification processor 12 performs time modification according to the radio wave time (T_{W}) once a day, and that the authentic time requesting unit 14 makes a request to the time server for the issue of the authentic time when “number of successive times |T_{W}−T_{N}′|<ε” becomes 90, the correction process according the authentic time (T_{N}) is performed when the local time (T_{N}′) deviates from the genuine time by a maximum of 45 seconds (90×0.5). Thus, the deviation of the local time (T_{N}′) can be kept within the predetermined value even if a false radio wave is fed combined with temperature assault.

Forcible request for the issue of the authentic time is accomplished by the user at any time by pressing the appropriate button to bring about forcible request for the authentic time with the aid of the input unit 6, causing the authentic time requesting unit 14 to make a request to the time server on the network for the issue of the authentic time. Forcible request may also be accomplished by displaying “number of successive times |T_{W}−T_{N}′|<ε or period in which |T_{W}−T_{N}′|<ε” or “number of successive times |T_{W}−T_{N}′|≧ε, or period in which |T_{W}−T_{N}′|≧ε” on the display unit 5 and urging the user to select forcible request.

The authentic time requesting unit 14 may not await user operation to act as a trigger for making a request for the authentic time but may on its own periodically make a request to the time server for the authentic time based on the local time (T_{N}′) generated by the local time generating unit 13. For instance, if the deviation of the local time from the standard time is 0.5 second per day, to keep the difference between the standard time and the local time within 45 seconds, the authentic time requesting unit 14 may be instructed to make a request to the time server for the authentic time once every 90 days.

The authentic time receiving unit 15 receives the authentic time (T_{N}), issued by the time server in response to the request made by the authentic time requesting unit 14, via the communication interface unit 4, and passes on the authentic time (T_{N}) to the time correction processor 16. The authentic time receiving unit 15 decrypts the encrypted authentic time (T_{N}) using the authentication key stored in the authentication key storing unit 21.

The time correction processor 16 corrects the local time (T_{N}′) generated by the local time generating unit 13 according to the authentic time (T_{N}) received from the authentic time receiving unit 15. The reason for calling the time adjustment process as “modification” when it is performed based on the radio wave time, and the “correction” when it is performed based on the authentic time is explained next.

The radio wave time formerly was considered as a standard for the local time as the radio waves could be depended upon for their lack of delay and hence accuracy. However, since the radio wave time can be manipulated as explained with reference to FIG. 2, the radio wave time cannot be assumed to be completely reliable.

On the other hand, the authentic time is more reliable than the radio wave time as an authentication key is required to receive the authentic time. Therefore, to differentiate the time adjustments made according to the radio wave time and the authentic time, different names adjustment and correction, respectively, have been given for the processes.

The time correction processor 16 calculates an absolute value (|T_{N}−T_{N}′|) of the difference between the authentic time (T_{N}) and the local time (T_{N}′) and compares the absolute value (|T_{N}−T_{N}′|) with the predetermined threshold value (σ). If the absolute value (|T_{N}−T_{N}′|) is less than the threshold value (σ) (that is, if |T_{N}−T_{N}′|<σ), the time correction processor 16 replaces the local time (T_{N}′) with the authentic time (T_{N}).

If the absolute value (|T_{N}−T_{N}′|) is equal to or greater than the threshold value (σ) (that is, if |T_{N}−T_{N}′|≧σ), the time correction processor 16 instructs the authentic time requesting unit 14 to make a request for the authentic time (T_{N}) without correcting the local time (T_{N}′).

The time stamping processor 17 affixes the digital signature, including therein a time stamp, on the electronic document using the local time and the authentication key stored in the authentication key storing unit 21. Prior to being used by the time stamping processor 17, the local time, which is generated by the local time generating unit 13, is subjected to time modification and time correction by the time modification processor 12 and the time correction processor 16, respectively. Specifically, the time stamping processor 17 receives the electronic document to be digitally signed via the communication interface unit 4, affixes a digital signature on the electronic document, and outputs the digitally signed electronic document via the communication interface unit 4.

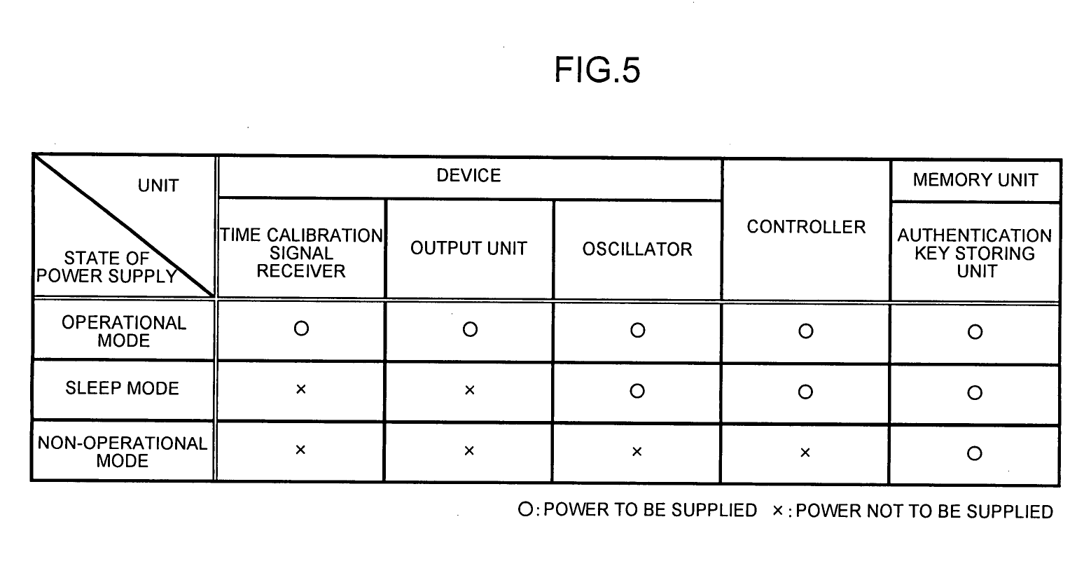

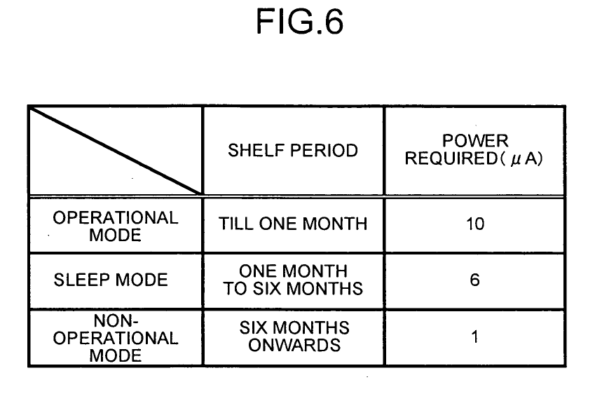

The power supply controller 18 controls the power supply to the various units during the “non-operational mode”, the “sleep mode”, and the “operational mode”. A process of the power supply controller 18 is explained with reference to FIG. 5 and FIG. 6. FIG. 5 is a drawing of an example of a relation between the operating modes and the units receiving the power supply. FIG. 6 is a drawing of an example of the power consumed in each of the operating modes.

As shown in FIG. 5, power is supplied to all the units of the time-stamping device 1 in the “operational mode”. Power is supplied to all the units except the time calibration signal receiver 2 and the display unit 5 in the “sleep mode”. Power is supplied only to the authentication key storing unit 21 in the “non-operational mode”.

By controlling the power supply, the amount of power consumption of the time-stamping device 1 can be reduced and the capacity of the battery 7, which is to be provided on the time-stamping device 1, can be reduced. As shown in FIG. 6, the amount of power required in the “non-operational mode” can be reduced to one tenth of the amount required in the “operational mode”.

Thus, a longer inventory period can be set for the time-stamping device 1 as compared to the conventional time-stamping device, and the battery 7, which is to be provided on the time-stamping device 1, can be made more compact. Moreover, changing the operating modes according to the shelf period can enhance the working life of the time-stamping device 1.

Referring back to FIG. 4, the memory unit 20 is explained next. The memory unit 20, which is a storage device including the volatile RAM, is provided with the authentication key storing unit 21 that stores the authentication key assigned beforehand when the time-stamping device 1 is manufactured. Power is constantly supplied to the memory unit 20 after the authentication key has been stored to prevent an unauthorized user from receiving hold of the authentication key. In other words, if an unauthorized user tries to disassemble the time-stamping device 1 to get hold of the authentication key, the power supply to the memory unit 20 is halted and the stored authentication key is also erased.

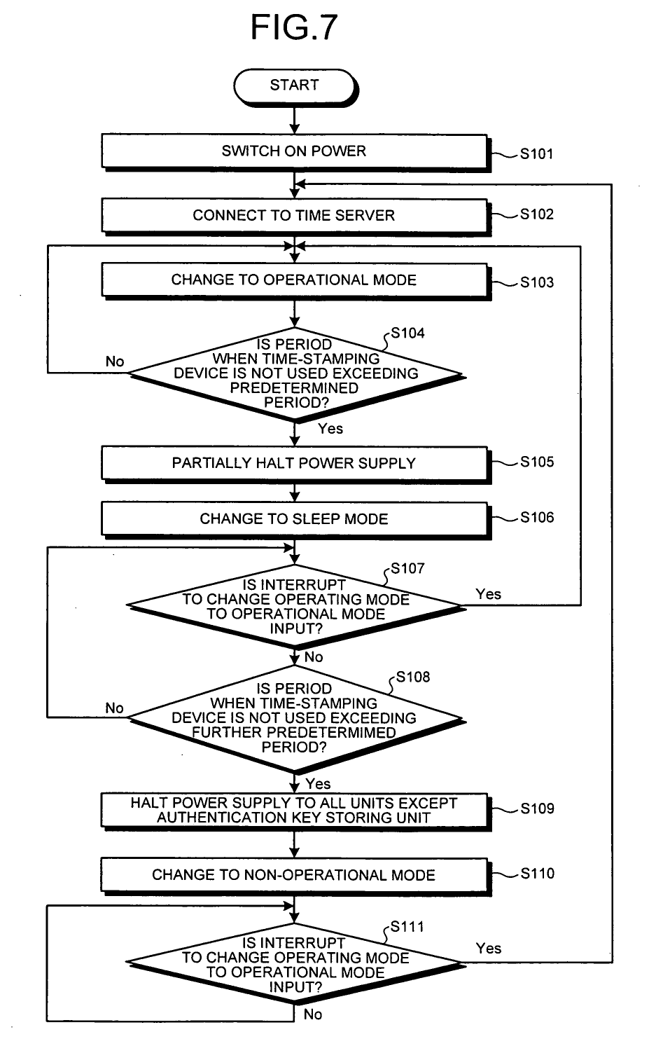

FIG. 7 is a flowchart of a sequence of the power supply controlling process, which is a feature of the present embodiment. When a purchaser of the time-stamping device 1 switches on the time-stamping device 1 (step S101) via the input unit 6, power is supplied to all the units of the time-stamping device 1. The authentic time requesting unit 14 connects the time-stamping device 1 to the time server via the communication interface unit 4 (step S102), receives the authentic time (T_{N}) and sets the received authentic time (T_{N}) as the local time (T_{N}′).

Next, the operating mode of the time-stamping device 1 changes from the “non-operational mode” to the “operational mode” based on the instruction from the power supply controller 18 (step S103). The time-stamping device 1 continues to remain in the “operational mode” if used continuously. The period when the time-stamping device 1 is not used is measured by means of a count up timer etc. The count up timer determines if the period when the time-stamping device 1 is not used has exceeded a predetermined period (step S104). A value corresponding to a month, for example, is set as the predetermined period at step S104.

If the period when the time-stamping device 1 is not used has exceeded the predetermined period (“Yes” at step S104), the power supply controller 18 partially halts the power supply (step S105) and the operating mode of the time-stamping device 1 changes from the “operational mode” to the “sleep mode” (step S106). As shown in FIG. 5, for example, the power supply to the time calibration signal receiver 2 and the display unit 5 is halted in the “sleep mode”.

If the period when the time-stamping device 1 is not used has not exceeded the predetermined period (“No” at step S104), the time-stamping device 1 remains in the “operational mode” and the process from step S103 onwards is repeated. If the user inputs an interrupt to change the operating mode to the “operational mode” by operating the input unit 6 or connecting the time-stamping device 1 to a personal computer via the communication interface unit 4 (“Yes” at step S107), the process from step S103 onwards is repeated.

If the interrupt to change the operating mode to the “operational mode” is not input (“No” at step S107) and the period when the time-stamping device 1 is not used has exceeded a further predetermined period (“Yes” at step S108), the power supply controller 18 halts the power supply to all the units except the authentication key storing unit 21 (step S109) and the operating mode of the time-stamping device 1 changes from the “sleep mode” to the “non-operational mode” (step S110). A value corresponding to six months, for example, are set as the predetermined period at step S108. If the period when the time-stamping device 1 is not used has not exceeded the predetermined period for changing the operating mode to the “non-operational mode” (“No” at step S108), the process from step S107 onwards is repeated.

If the user inputs the interrupt to change the operating mode to the “operational mode” by operating the input unit 6 or connecting the time-stamping device 1 to the personal computer via the communication interface unit 4 (“Yes” at step S111), the time-stamping device 1 is connected to the time server (step S102) and the process from step S103 onwards is repeated.

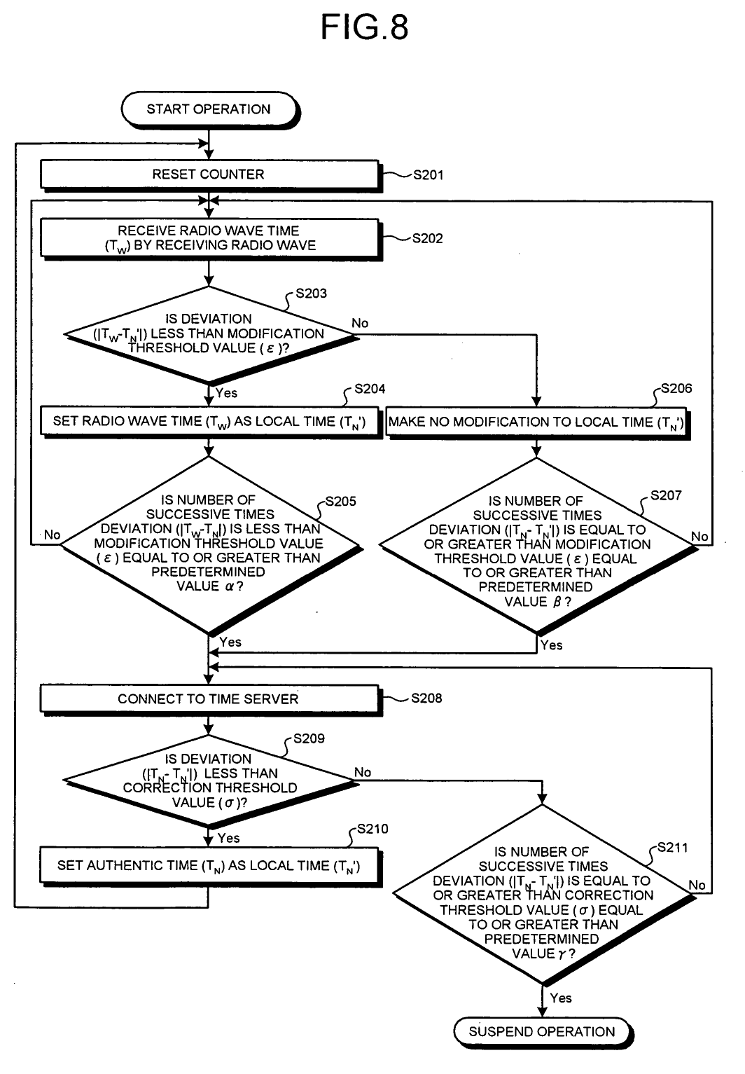

FIG. 8 is a flowchart of sequences of a time modification process and a time correction process when the time-stamping device 1 is in the “operational mode”. As shown in FIG. 8, when the time-stamping device 1 is activated, a counter, which calculates a successive count that is used in the subsequent processes, is reset (step S201). The radio wave time receiving unit 11 receives the radio wave time (T_{W}) via the time calibration signal receiver 2 (step S202).

The time modification processor 12 calculates the difference between the radio wave time (T_{W}) and the local time (T_{N}′) and determines whether the deviation (|T_{W}−T_{N}′|) is less than the modification threshold value (ε) (step S203). If the deviation (|T_{W}−T_{N}′|) is less than the modification threshold value (ε) (“Yes” at step S203), the time modification processor 12 performs a modification process by setting the radio wave time (T_{W}) as the local time (T_{N}′) (step S204).

Next, the time modification processor 12 determines whether the number of successive times the deviation (|T_{W}−T_{N}′|) is less than the modification threshold value (ε) is equal to or greater than a predetermined value α (step S205). If the number of successive times the deviation (|T_{W}−T_{N}′|) is less than the modification threshold value (ε) is found to be equal to or greater than α (“Yes” at step S205), the steps from Step S208 onward are carried out. If the number of successive times the deviation (|T_{W}−T_{N}′|) is less than the modification threshold value (ε) is found to be less than the predetermined value α (“No” at step S205), the steps from Step S202 onward are repeated.

If the deviation (|T_{W}−T_{N}′|) is equal to or greater than the modification threshold (“No” in step S203), the time modification processor 12 makes no modification to the local time (T_{N}′) (step S206). The time modification processor 12 then determines whether the number of successive times (|T_{W}−T_{N}′|) is equal to or greater than the modification threshold value (ε) is equal to or greater than a predetermined value β (step S207). If the number of successive times the deviation (|T_{W}−T_{N}′|) is equal to or greater than the modification threshold value (ε) is found to be equal to or greater than a predetermined value β (“Yes” at step S207), the steps from step S208 onward are carried out. If the number of successive times the deviation (|T_{W}−T_{N}′|) is less than the modification threshold value (ε) is found to be less than the predetermined value β (“No” at step S207), the steps from step S202 onward are repeated.

If the answer is “Yes” at steps S205 and S207, the authentic time requesting unit 14 connects to the time server for making a request for the authentic time (T_{N}) (step S208). The time correction processor 16 receives the authentic time (T_{N}) via the authentic time receiving unit 15, calculates the difference between the received authentic time (T_{N}) and the local time (T_{N}′), and determines whether the deviation (|T_{N}−T_{N}′|) is smaller than the correction threshold value (σ) (step S209).

If the deviation (|T_{N}−T_{N}′|) is less than the correction threshold value (σ) (“Yes” at step S209), the time correction processor 16 sets the authentic time T_{N} as the local time T_{N}′ (step S210), and the steps from step S201 onward are repeated. If the deviation (|T_{N}−T_{N}′|) is equal to or greater than the correction threshold value (σ) (“No” at step S209), the time correction processor 16 determines whether the number of successive times the deviation (|T_{N}−T_{N}|) is equal to or greater than the correction threshold value (σ) is equal to or greater than a predetermined value γ (step S211). If the deviation (|T_{N}−T_{N}′|) is equal to or greater than the correction threshold value (σ) is found to be equal to or greater than the predetermined value γ (“Yes” at step S211), the time correction processor 16 suspends the operation of the time-stamping device 1. If the number of successive times the deviation (|T_{N}−T_{N}′|) is equal to or greater than the correction threshold value (σ) is found to be less than the predetermined value γ (“No” at step S211), the steps from step S208 onward are repeated.

In the time-stamping device according to the present embodiment, a time modification processor modifies the local time by means of a radio wave time, and a time correction processor, upon satisfaction of predetermined conditions, receives an authentic time from a time server to correct the local time. A power supply controller controls the power supply to all the units except an authentication key storing unit. When the operating mode of the time-stamping device changes from a “non-operational mode” to an “operational mode”, the time correction processor receives the authentic time from the time server to correct the local time. The power supply controller supplies power to the various units according to the length of the period when the time-stamping device is not used. Thus, the falsification of the local time by an unauthorized user can be prevented and the power consumption of the time-stamping device during an inventory period and an operational period can be reduced.

A power supply controlling process applied to the time-stamping device is explained in the embodiment. However, the power supply controlling process can also be applied to a security device that sends and receives data by means of an authentication key, or a time-correcting device that receives an authentic time from a time server by means of an authentication key to correct the local time.

In the time-stamping device according to the embodiment, a memory unit including a volatile RAM is provided that stores an authentication key and from the inventory period onwards, power is continuously supplied to the memory unit to prevent leakage of the authentication key. However, the memory unit including the volatile RAM can be provided after taking measures to prevent leakage of the authentication key, and the power consumption of the time-stamping device during the inventory period and the shelf period can be reduced to zero. For example, the memory unit of the time-stamping device can be provided inside a case so that the authentication key would be erased when the case is opened, thereby preventing the leakage of the authentication key.

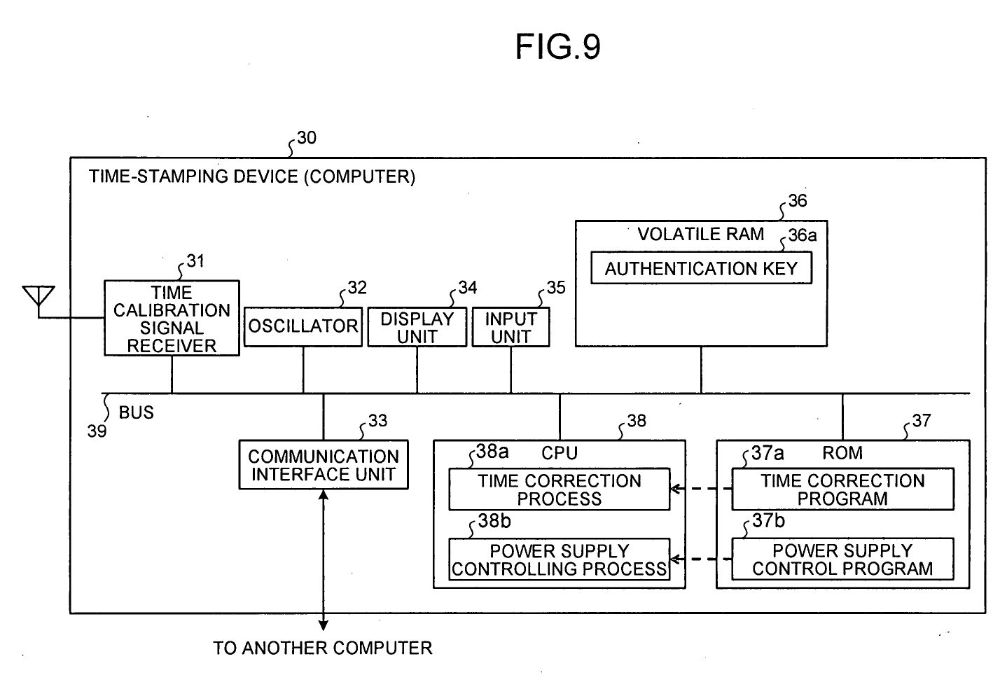

The various processes explained in the present embodiment can be realized by a ready program installed in a computer. FIG. 9 is a schematic diagram of a computer that executes a time correction program and a power supply control program with the functions explained in the above embodiment.

The word “computer” refers not only to personal computers, but also the so-called “built-in computer” built into devices such as digital cameras, digital video cameras, etc. The authenticity of data and time on electronic data such as text data, image data, video data, etc. can be guaranteed by enabling the execution of the time correction program on these computers.

As shown in FIG. 9, a computer 30 that functions as the time-stamping device includes a time calibration signal receiver 31, an oscillator 32, a communication interface unit 33, a display unit 34, an input unit 35, a volatile RAM 36, a read-only memory (ROM) 37, a central processing unit (CPU) 38, and a bus 39 that connects all the aforementioned parts. The time calibration signal receiver 31, the oscillator 32, the communication interface unit 33, the display unit 34, and the input unit 35 of FIG. 9 correspond respectively to the time calibration signal receiver 2, the oscillator 3, the communication interface unit 4, the display unit 5, and the input unit 6 shown in FIG. 4. The computer 30 is connected to another computer, the network, etc. via the communication interface unit 33.

A time correction program 37a and a power supply control program 37b are stored beforehand in the ROM 37. As shown in FIG. 9, the CPU 38 reads and executes these programs so that the time correction program 37a functions as a time correction process 38a, and the power supply control program 37b functions as a power supply controlling process 38b. An authentication key 36a is stored in the volatile RAM 36. The authentication key 36a is used when the time correction program 37a carries out the time correction process 38a.

The time correction program 37a and the power supply control program 37b need not be stored beforehand in the ROM 37. The programs can be stored in a “portable physical medium” such as a flexible disk (FD), a compact disk-read only memory (CD-ROM), a magneto optical disk etc. that can be read by the computer 30, or the programs can be stored in “other computer (or server)” that is connected to the computer 30 via a public circuit, the Internet, a LAN, a wide area network (WAN) etc. The programs can be read by the computer 30 from the aforementioned media and executed.

According to the present invention, the time-stamping device can enhance the accuracy of the local time provided to an authorized user, since falsification of the local time by an unauthorized user can be effectively prevented after a reliable time is received from the time server at the start of the time-stamping device. Furthermore, the power consumption of the time-stamping device during an inventory period and an operational period can be reduced, and therefore the battery provided on the time-stamping device can be made more compact, since the power supply to each unit of the time-stamping device is controlled according to the usage state of the time-stamping device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A time-stamping device that affixes a digital signature including a local time clocked by an internal clock to electronic data, the time-stamping device comprising:
an authentication-key storing unit that stores an authentication key;
an authentic-time receiving unit that receives an authentic time synchronized with a standard time from a time server by sending a request including the authentication key stored;
a time correcting unit that corrects the local time based on the authentic time received; and
a power-supply control unit that supplies a power to a plurality of units included in the time-stamping device, wherein
the power-supply control unit keeps on supplying the power to the authentication key storing unit.

2. The time-stamping device according to claim 1, further comprising:
a radio-transmitted-time receiving unit that receives the standard time included in a time calibration signal as a radio-transmitted time;
a calculating unit that calculates an absolute value of a difference between the radio-transmitted time and the local time; and
a time modifying unit that modifies the local time by setting the radio-transmitted time as the local time when the absolute value calculated is less than a threshold value.

3. The time-stamping device according to claim 1, wherein the power-supply control unit, upon starting supplying the power to the internal clock, instructs the authentic-time receiving unit to receive the authentic time.

4. The time-stamping device according to claim 1, wherein the power-supply control unit, upon receiving an instruction to start operation of the time-stamping device, starts supplying the power to all of the units included in the time-stamping device.

5. The time-stamping device according to claim 1, wherein the power-supply control unit stops supplying the power to a part of the units included in the time-stamping device when a period during which the time-stamping device does not affix the digital signature to the electronic data exceeds a threshold value.

6. The time-stamping device according to claim 1, wherein the power-supply control unit stops supplying the power to a part of the units that are included in the time-stamping device and other than the authentication-key storing unit when a period during which the time-stamping device does not affix the digital signature to the electronic data exceeds a threshold value.

7. A method for supplying a power to a time-stamping device that affixes a digital signature including a local time clocked by an internal clock to electronic data, the method comprising:
storing an authentication key in a storage unit of the time-stamping device;
receiving an authentic time synchronized with a standard time from a time server by sending a request including the authentication key stored;
correcting the local time based on the authentic time received; and
supplying a power to a plurality of units included in the time-stamping device, wherein
the power is continually supplied to the storage unit.

8. The method according to claim 7, further comprising:
receiving the standard time included in a time calibration signal as a radio-transmitted time;
calculating an absolute value of a difference between the radio-transmitted time and the local time; and
modifying the local time by setting the radio-transmitted time as the local time when the absolute value calculated is less than a threshold value.

9. The method according to claim 7, wherein the receiving includes receiving the authentic time when the power is supplied to the internal clock.

10. The method according to claim 7, wherein the power is supplied to all of the units included in the time-stamping device when the time-stamping device is started.

11. The method according to claim 7, further comprising stopping supplying the power to a part of the units included in the time-stamping device when a period during which the time-stamping device does not affix the digital signature to the electronic data exceeds a threshold value.

12. The method according to claim 7, further comprising stopping supplying the power to a part of the units that are included in the time-stamping device and other than the storage unit when a period during which the time-stamping device does not affix the digital signature to the electronic data exceeds a threshold value.

13. A computer-readable recording medium that stores a computer program for supplying a power to a time-stamping device that affixes a digital signature including a local time clocked by an internal clock to electronic data, wherein the computer program causes a computer to execute:
storing an authentication key in a storage unit of the time-stamping device;
receiving an authentic time synchronized with a standard time from a time server by sending a request including the authentication key stored;
correcting the local time based on the authentic time received; and
supplying a power to a plurality of units included in the time-stamping device, wherein
the power is continually supplied to the storage unit.

14. The computer-readable recording medium according to claim 13, wherein the computer program further causes the computer to execute:
receiving the standard time included in a time calibration signal as a radio-transmitted time;
calculating an absolute value of a difference between the radio-transmitted time and the local time; and
modifying the local time by setting the radio-transmitted time as the local time when the absolute value calculated is less than a threshold value.

15. The computer-readable recording medium according to claim 13, wherein the receiving includes receiving the authentic time when the power is supplied to the internal clock.

16. The computer-readable recording medium according to claim 13, wherein the power is supplied to all of the units included in the time-stamping device when the time-stamping device is started.

17. The computer-readable recording medium according to claim 13, wherein the computer program further causes the computer to execute stopping supplying the power to a part of the units included in the time-stamping device when a period during which the time-stamping device does not affix the digital signature to the electronic data exceeds a threshold value.

18. The computer-readable recording medium according to claim 13, the computer program further causes the computer to execute stopping supplying the power to a part of the units that are included in the time-stamping device and other than the storage unit when a period during which the time-stamping device does not affix the digital signature to the electronic data exceeds a threshold value.

19. A security device that sends and receives data by means of an authentication key, the security device comprising:
an authentication-key storing unit that stores the authentication key; and
a power-supply control unit that supplies a power to a plurality of units included in the security device, wherein
the power-supply control unit keeps on supplying the power to the authentication key storing unit.

20. A time-correcting device that corrects a local time by receiving an authentic time from a time server by means of an authentication key, the time-correcting device comprising:
an authentication-key storing unit that stores the authentication key; and
a power-supply control unit that supplies a power to a plurality of units included in the time-correcting device, wherein
the power-supply control unit keeps on supplying the power to the authentication key storing unit.
